(19) United States
(12) Patent Application Publication
(10) Pub. No.: US 2026/0298402 A1
(43) Pub. Date: Oct. 1, 2026

(54) MODULAR DECORATIVE SYSTEM AND METHODS OF USE

(71) Applicant: Jewish Joy LLC, West Hartford, CT (US)

(72) Inventor: Kenneth Zablotsky, West Hartford, CT (US)

(73) Assignee: Jewish Joy LLC, West Hartford, CT (US)

(21) Appl. No.: 19/537,796

(22) Filed: Feb. 12, 2026

Related U.S. Application Data
(60) Provisional application No. 63/773,255, filed on Mar. 17, 2025.

(51) Int. Cl. F16M 11/22

(52) U.S. Cl. CPC F16M 11/22

(57) ABSTRACT

The disclosed decorative fixture system is designed for versatility and interchangeability, enabling users to create multiple configurations with ease. The system includes a first base, a second base, an extension rod, and a decorative figure. The first base features prongs at one end for ground penetration and a first attachment feature at the opposite end. The second base has a flat bottom for placement on surfaces and a second attachment feature. The extension rod includes third and fourth attachment features at its respective ends, while the decorative figure incorporates a fifth attachment feature. The first and second attachment features can selectively couple with either the fourth or fifth attachment features, and the third attachment feature can couple with the fifth attachment feature. This modular design allows users to attach or detach components quickly and supports the addition of extra fixtures, expanding decorative possibilities for both indoor and outdoor settings.

### PRIORITY CLAIM

This application claims priority to U.S. Provisional Application No. 63/773,255, filed Mar. 17, 2025, the contents of which are incorporated by reference herein in its entirety.

### BACKGROUND OF THE DISCLOSED SUBJECT MATTER

### Field of the Disclosed Subject Matter

The disclosed subject matter is directed to modular decorative systems and methods of use. In particular, the disclosed subject matter enables decorative fixtures to be mounted in a plurality of ways through the use of interchangeable components.

### Description of the Related Art

Decorative fixtures play a significant role in enhancing the visual appeal and ambiance of gardens and outdoor living areas. Garden decorations enhance the aesthetic appeal of outdoor spaces. However, conventional decorative systems often lack flexibility in changing the decorative piece, requiring the need to buy separate units for each purpose. This can be inconvenient for users who wish to change decorations seasonally or for different needs such as yard or tabletop placement. Furthermore, conventional decorative systems often break after one season and are not structurally sound for repeated use, which is cost inefficient. Accordingly, there is a need for a decoration system that provides versatile mounting and coupling options using an interchangeable set of components.

With growing interest in personalizing outdoor spaces, there is an increasing demand for systems that offer both flexibility, durability, cost efficiency, and convenience in displaying seasonal or thematic decorations. There thus remains a continued need for improved modular decorative systems and methods of use.

### SUMMARY OF THE DISCLOSED SUBJECT MATTER

The purpose and advantages of the disclosed subject matter will be set forth in and are apparent from the description that follows, as well as will be learned by practice of the disclosed subject matter. Additional advantages of the disclosed subject matter will be realized and attained by the devices particularly pointed out in the written description and claims hereof, as well as from the appended drawings.

To achieve these and other advantages and in accordance with the purpose of the disclosed subject matter, as embodied and broadly described, the disclosed subject matter can include a decorative system including a first base, a second base, an extension rod, and a decorative figure. The first base can include a first end including a plurality of prongs configured to penetrate a ground and a second end having a first attachment feature. The second base can include a first end including a flat bottom configured to be disposed on a surface and a second end having a second attachment feature. The extension rod can include a first end having a third attachment feature and a second end having a fourth attachment feature. The decorative fixture can include a first end including a fifth attachment feature. The first attachment feature and second attachment feature are each configured to selectively couple with any of the fourth attachment feature and the fifth attachment feature and the third attachment feature is configured to selectively couple with the fifth attachment feature.

In accordance with the disclosed subject matter, the decorative system can include a stabilizing rod. One end of this rod (the second end) can be threaded (like a screw) or magnetic. There are decorative fixtures that connect to this end, and they can be designed to match the type of connection, either screwing in or attaching magnetically.

In accordance with the disclosed subject matter, the decorative system can include an extension rod. This extension rod can be designed to connect to the stabilizing rod at its second end, and it can also connect to the decorative fixture.

In accordance with the disclosed subject matter, the decorative system can include various other fixtures that can be attached and removed. These fixtures can include a birdbath, a bird feeder, a decorative ornament, a religious symbol, a plant holder, a candle holder, or a climbing trellis tube, including others. These fixtures can also take the form of ornamental shapes such as stars, flowers, animals, or culturally significant symbols. The interchangeable nature of the fixtures enables users to update the design of the pole in accordance with seasonal changes or specific occasions.

In accordance with the disclosed subject matter, the decorative system can include a second base, which has a flat bottom. The flat bottom can be designed to support decorative fixtures on a tabletop or other flat surface.

In accordance with the disclosed subject matter, the base of the decorative system can come in different lengths and widths so it can be placed on tabletop settings of various sizes.

In accordance with the disclosed subject matter, the decorative system can include a birdbath or bird feeder. The birdbath or bird feeder can include a recessed bowl designed to hold water or birdseed.

In accordance with the disclosed subject matter, the decorative system can include windchimes, which can allow for movement for sound aesthetics.

In accordance with the disclosed subject matter, the decorative system can include ornaments for decorative purposes. These ornaments can include hangers with weighted balls.

In accordance with the disclosed subject matter, the decorative system can also include religious symbols such as a menorah, Hamsa, mezuzah, depiction of a human, or cross.

In accordance with the disclosed subject matter, the decorative system can include a climbing trellis design which can consist of a cylindrical tube with multiple holes for plants.

In accordance with the disclosed subject matter, the decorative fixtures can include small openings or cutouts. These cutouts can be designed to block certain light from passing through and allow other light to pass through, so the cutouts can create a shadow or image on the ground or surface below.

In accordance with the disclosed subject matter, the rod and the fixtures in the decorative system can be plastic or metal, and can include a protective weather coating for all year use outdoors. The system is designed for continuous outdoor application throughout the year, especially when fabricated with powder-coated metal finishes that enhance resistance to environmental factors. These metals are chosen for their robust durability and visual appeal. Appropriate materials can include stainless steel, copper, and powder-coated steel. The extendable pole consists of interlocking segments engineered to accommodate a range of attachments.

In accordance with the disclosed subject matter, the decorative system can include bases of various lengths and diameters for use in both tabletop placement and various different decorative configurations.

In accordance with the disclosed subject matter, the decorative system can include a method for assembly. The method for assembly includes attaching and securing the various sections of the rod together for either tabletop placement or for placement within a garden.

In accordance with the disclosed subject matter, the decorative system can include a user kit where all components such as the bases, extension rods and decorative fixtures are configured for interchangeable assembly without specialized tools, and the kit includes instructions for assembling the system in multiple configurations for ground or tabletop placement. The user kit allows users to mix and match decorative pieces without worrying about compatibility. In accordance with the disclosed subject matter, the decorative system consists of a decorative garden pole system with two components: an extendable pole and a collection of interchangeable topper elements. The pole provides dual functionality for placement either into the ground or on a tabletop base. The topper components can be selected from a range of shapes and designs, allowing adjustment of the pole's appearance in accordance with seasonal themes, events, or user preference.

### BRIEF DESCRIPTION OF THE DRAWINGS

The subject matter of the application will be more readily understood from the following detailed description when read in conjunction with the accompanying drawings, in which:

FIG. 1 shows an illustrative decorative system in accordance with the disclosed subject matter.

FIG. 2 is an illustrative tabletop placement of the decorative fixture illustrated in FIG. 1 in accordance with the disclosed subject matter.

FIGS. 3A-F provide various views of an alternate decorative fixture design of the decorative figure illustrated in FIG. 2, in accordance with the disclosed subject matter.

FIG. 4A-G provide various views of the decorative system shown in FIG. 1.

FIG. 5 provides an exemplary configuration of the decorative system shown in FIG. 1 in accordance with the disclosed subject matter.

FIG. 6 is an exemplary decorative fixture including a climbing trellis tube in accordance with the disclosed subject matter.

FIG. 7 is an exemplary decorative fixture including a birdbath or birdfeeder in accordance with the disclosed subject matter.

FIG. 8 is an exemplary decorative fixture including a windchime disc in accordance with the disclosed subject matter.

FIG. 9 is an exemplary decorative fixture including a planter or menorah holder in accordance with the disclosed subject matter.

### DETAILED DESCRIPTION

Reference will now be made in detail to embodiments of the disclosed subject matter, an example of which is illustrated in the accompanying drawings. The disclosed subject matter will be described in conjunction with the detailed description of the system.

To address the challenges noted above, the disclosed subject matter introduces a modular decorative system designed to accommodate a wide variety of decorative fixtures. This system utilizes a core set of interchangeable components that can be assembled, disassembled, and reconfigured to suit different mounting preferences, including for ground installation or surface placement, desired height, and desired decoration. By eliminating the need for multiple individual, specialized decorations, users can effortlessly update their outdoor decor to reflect changing seasons, holidays, or personal tastes.

As disclosed herein, the devices presented herein can be used for a variety of different purposes including but not limited to garden decoration, tabletop decoration, windchime, climbing trellis tube, bird bath, bird feeder, menorah stand, and planter among others.

In accordance with the disclosed subject matter, the disclosed subject matter includes a decorative system including a first base, a second base, an extension rod, and a decorative figure. The first base can include a first end including a plurality of prongs configured to penetrate a ground and a second end having a first attachment feature. The second base can include a first end including a flat bottom configured to be disposed on a surface and a second end having a second attachment feature. The extension rod can include a first end having a third attachment feature and a second end having a fourth attachment feature. The decorative fixture can include a first end including a fifth attachment feature. The first attachment feature and second attachment feature are each configured to selectively couple with any of the fourth attachment feature and the fifth attachment feature and the third attachment feature is configured to selectively couple with the fifth attachment feature.

In addition to the pole and topper components, the system can include a range of optional garden accessories. These accessories can include a climbing trellis tube for supporting plants, an ornament or wind chime disc for aesthetic and auditory enhancement, a birdbath or birdfeeder, and a planter or menorah for additional decorative or cultural expression. All components of the system are designed to be interchangeable and modular, allowing users to assemble and reconfigure the elements without the need for specialized tools.

The fixtures can be designed with standardized connectors that allow secure attachment to the pole.

Accessory components can be engineered to integrate modularly with the pole system. The climbing trellis tube can offer robust support for plants and vines, while the ornament and/or wind chime disc introduces both visual and auditory enhancements to the garden setting. The birdbath or birdfeeder fixture function to attract and sustain local bird species. In addition, the planter or menorah options provide additional decorative or cultural value according to user preference. Powder-coated finishes improve weather resistance, ensuring all components remain durable under continuous outdoor exposure. The modular design promotes ease of customization, allowing users to effortlessly tailor their garden displays with optimal flexibility.

In accordance with the disclosed subject matter, the decorative system can include a climbing trellis tube which can include a 15-inch perforated cylindrical element constructed from the same metal finish as the pole and topper components.

In accordance with the disclosed subject matter, the decorative system can include a birdbath or birdfeeder disc designed for integration with a decorative system. The disc can have a diameter of approximately 8 inches and can include a curved, bowl-shaped interior recess with a depth of approximately ¼ inch.

In accordance with the disclosed subject matter, the decorative system can include a windchime disc designed for integration with a decorative system. The disc can have a diameter of approximately 8 inches and can include a specialty perforated design that allows for the attachment of decorative elements.

In accordance with the disclosed subject matter, the decorative system can include a dual-function planter and menorah, or candle holder disc designed for integration with the decorative system.

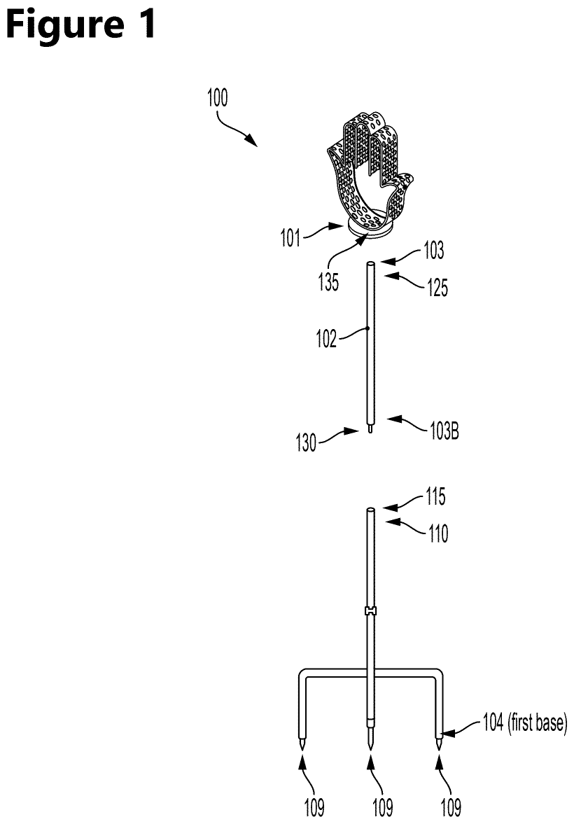

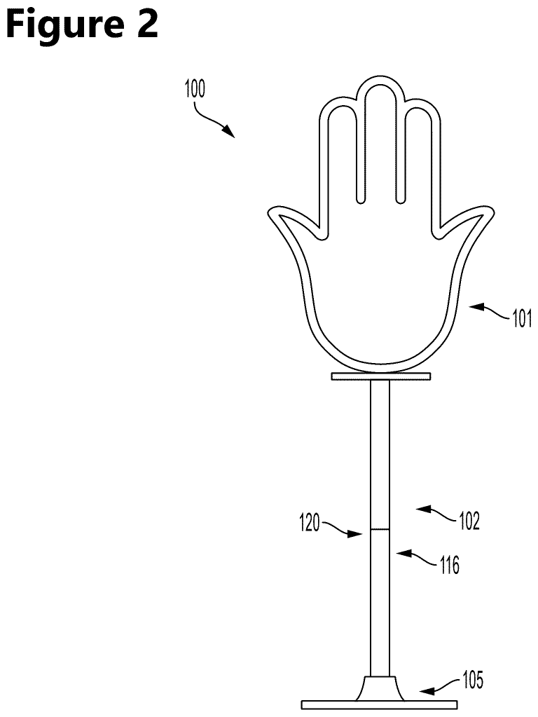

Referring to FIGS. 1-5 for purpose of illustration and not limitation, an exemplary modular decorative system is shown. As depicted in FIG. 1, the decorative system 100 can include a decorative fixture 101, an extension rod 102, a first base 104 and a second base 105 (FIG. 2). The decorative fixture 101 can be optionally coupled with a first end 103 of the extension rod 102, the first base 104, or the second base 105. Accordingly, the decorative system 100 is modular such that different configurations can be formed between the decorative fixture 101, extension rod 102, first base 104 and second base 105. For example, the first base 104 can have a second end 115 having a first attachment feature 110. The second base 105 can have a second end 116 having a second attachment feature 120. The extension rod 102 can have a first end 103 having a third attachment feature 125 and a second end 103B having a fourth attachment feature 130. The decorative fixture 101 can have a fifth attachment feature 135. The decorative fixture 101 can connect to the first end 103 of the extension rod 102 with the fifth attachment feature 135 coupled to the third attachment feature 125. The first attachment feature 110 and second attachment feature 120 can each be configured to selectively couple with any of the fourth attachment feature 130 and fifth attachment feature 135. Likewise, the third attachment feature 125 can be configured to selectively couple with the fifth attachment feature 135. In this manner, decorative fixture 101 can be coupled directly to the second base 105 by connecting the fifth attachment feature 135 of the decorative fixture 101 with the first attachment feature 110 of the first base 104. Likewise, the decorative fixture can be coupled directly to the second base 105 by connecting the fifth attachment feature 135 of the decorative fixture 101 with the second attachment feature 120 of the second base 105. Alternatively, the decorative fixture 101 can be coupled to the extension rod 102 by coupling the fifth attachment feature 135 of the decorative fixture 101 with the third attachment feature 125 of the extension rod 102, while the fourth attachment feature 130 of the extension rod can be coupled with either of the first attachment feature 135 of the first base 104 or the second attachment feature 120 of the second base 105.

The decorative fixture 101 can be formed in a variety of shapes and serve multiple functions. For example, the decorative fixture 101 can take the form of a peace sign, a Hamsa, or other symbolic designs. Beyond decorative elements, the decorative fixture 101 can also function as a birdbath, bird feeder, wind chime, candle holder, or other ornamental embodiments.

The decorative fixture 101 can be attached to the extension rod 102, first base 104 or second base 105 in a variety of ways including for example, male and female connectors, threaded couplings, magnetic couplings, and ball-and-detent assemblies, enabling secure yet easily releasable engagement between components. For example, each of the first attachment feature 110, second attachment feature 120, and third attachment feature 125 can include a male threaded portion, and each of the fourth attachment feature 130 and fifth attachment feature 135 can include a female threaded portion (or vice versa). As another example, each of the attachment features can include magnets arranged such that any of the first attachment feature 110 and second attachment feature 120 can be magnetically coupled to any of the fourth attachment feature 130 or fifth attachment feature 135, and likewise the third attachment feature 125 can be magnetically coupled to the fifth attachment feature 135.

The first base 104 can be configured in various forms to facilitate penetration into the ground. For example, first base 104 can including a single tapered point or multiple prongs—typically three or four. For example, and as shown in FIG. 1, for purpose of illustration and not limitation, first base 104 can include three prongs 109 disposed opposite the first attachment feature 110. The prongs can be disposed linearly, or in other configurations, such as an X-shaped configuration. Although three prongs are shown, any suitable number of prongs can be used. For example, there can be five prongs to anchor into the ground and stabilize. The prongs can fold flat for shipping and then can be expanded into an X formation with a central fifth prong.

Referring still to FIG. 1, the system 100 can include an all-weather coating for usage outdoors throughout the year. Some examples of all-weather coating materials can include polymers such as epoxy, moisture-cure urethane, and polyurethane, which help protect against potentially damaging weather when used year-round outside.

FIG. 2 shows the system 100 of FIG. 1 with second base 105 for placement on a horizontal flat surface, such as a tabletop, fireplace mantel, countertops, outdoor living spaces. Second base 105, like first base 104, can be coupled directly to decorative fixture 101, or to decorative fixture 101 by way of extension rod 102. Decorative fixture 101 is shown as a Hamsa, including a plurality of holes 106 disposed therein. The holes 106 can add to the decorative appearance of the decorative fixture 101, and can affect light passing through, to add to the decorative appearance around the decorative fixture 101.

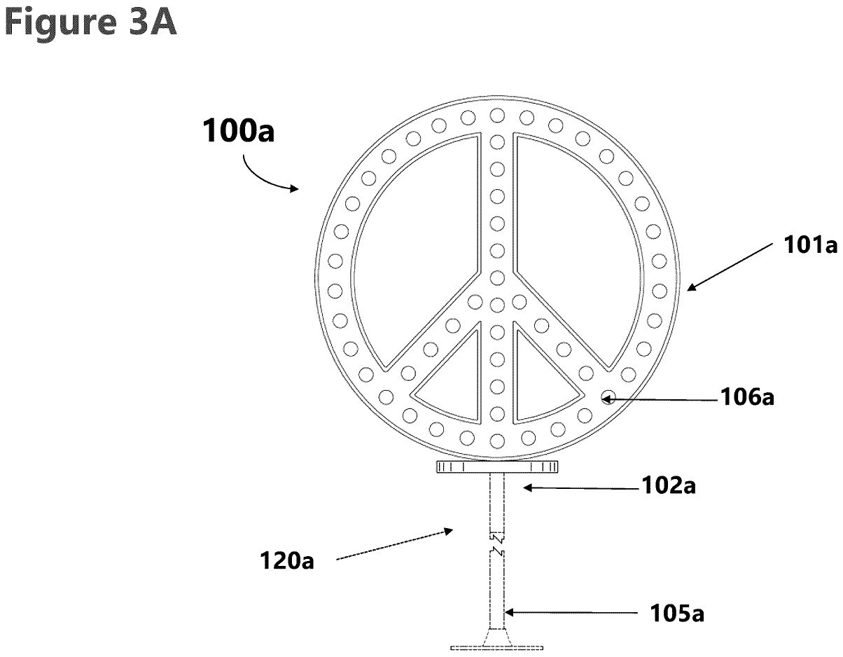

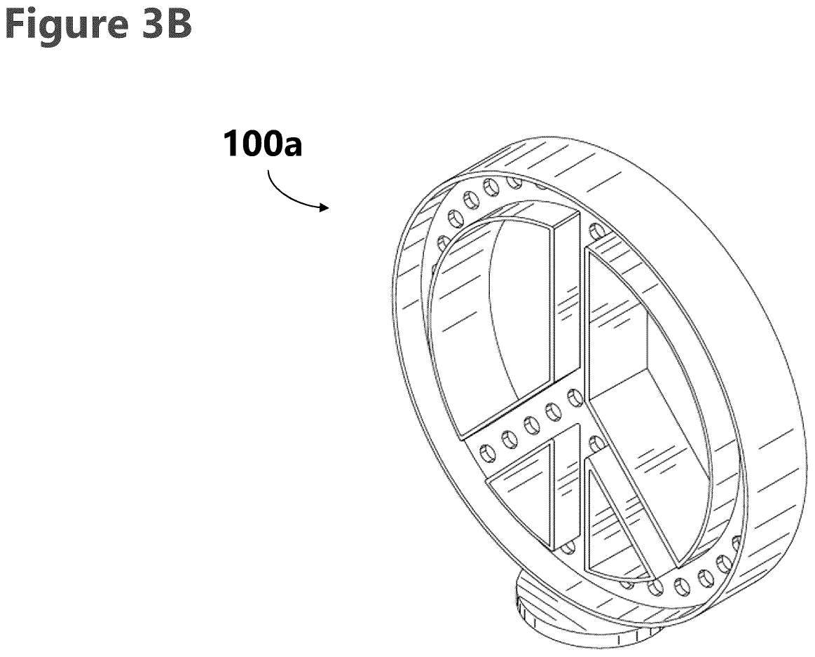

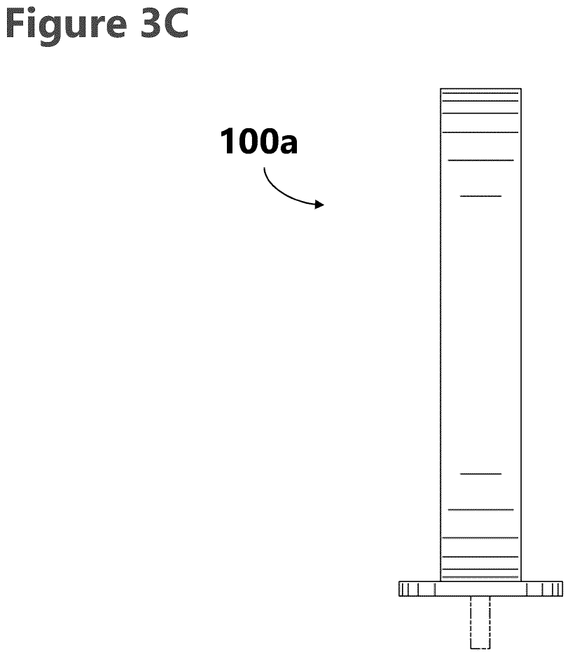

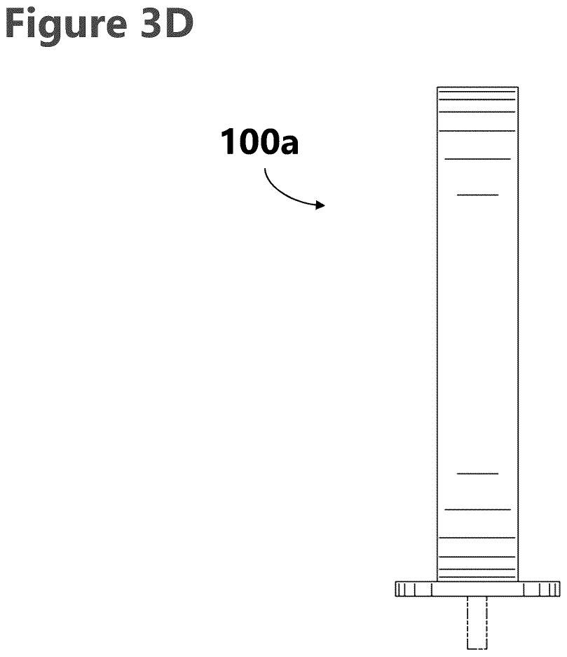

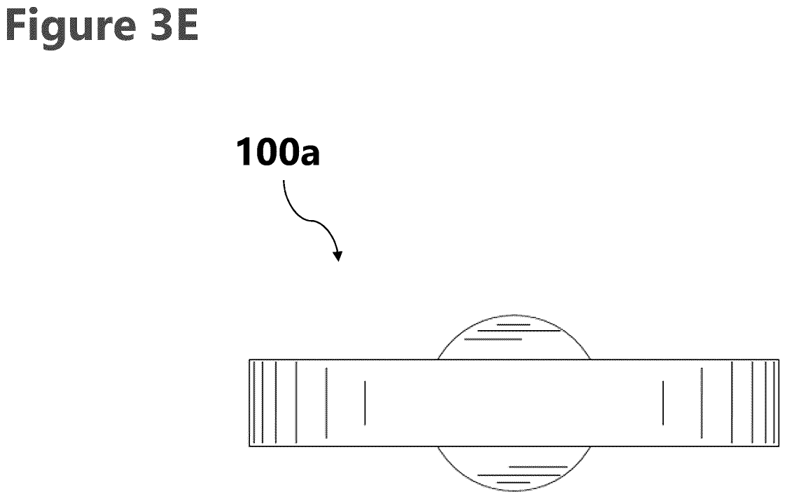

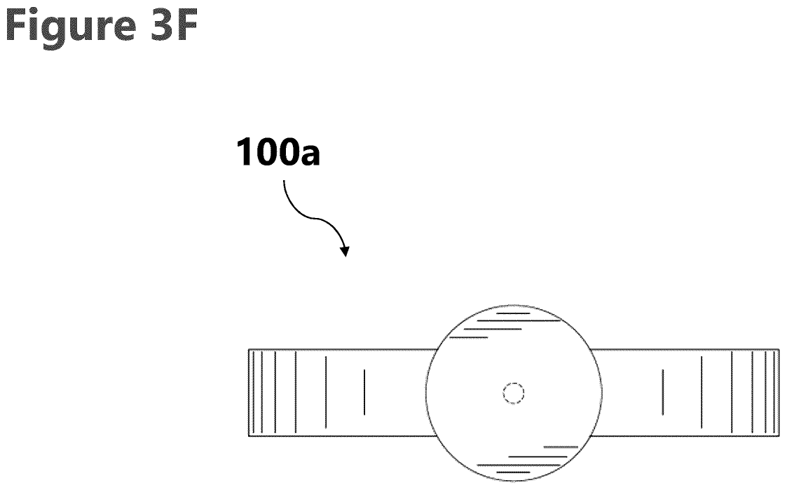

FIGS. 3A-F show, for purpose of illustration and not limitation, an alternate design of the decorative fixture illustrated in FIG. 2. As shown in FIG. 3A, the system 100a can include a decorative fixture 101a, which can be attached to an extension rod 102a, and a second base 105a. Although shown with a second base 105a, configured for table top placement, the system 100a can be connected with a first base (like first base 104) for placement in the ground. Decorative fixture 101a is shown as a peace sign, including a plurality of holes 106a disposed therein. The holes 106a can add to the decorative appearance of the decorative fixture 101a, and can affect light passing through, to add to the decorative appearance around the decorative fixture 101a. FIG. 3B shows a perspective view of the system 100a; FIGS. 3C and 3D show left and right-side views, respectively, of the system 100a. FIGS. 3E and 3F show top and bottom views, respectively, of the system 100a.

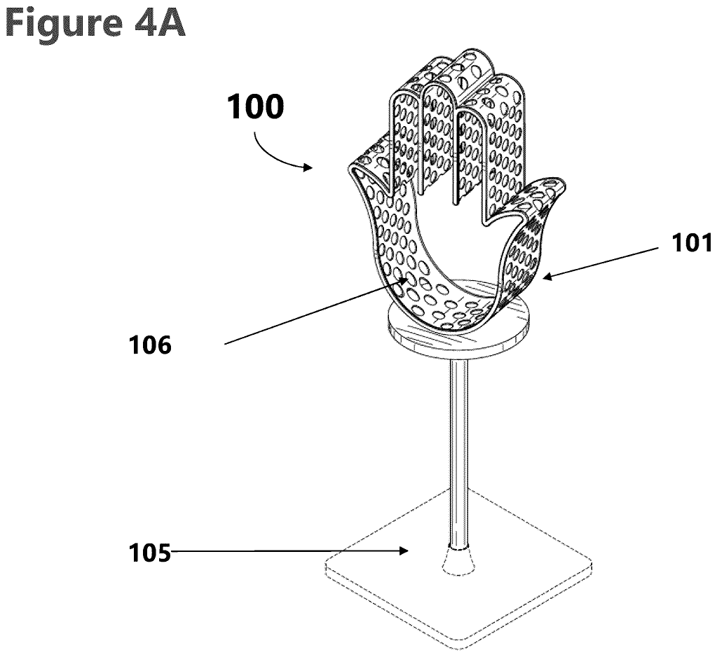

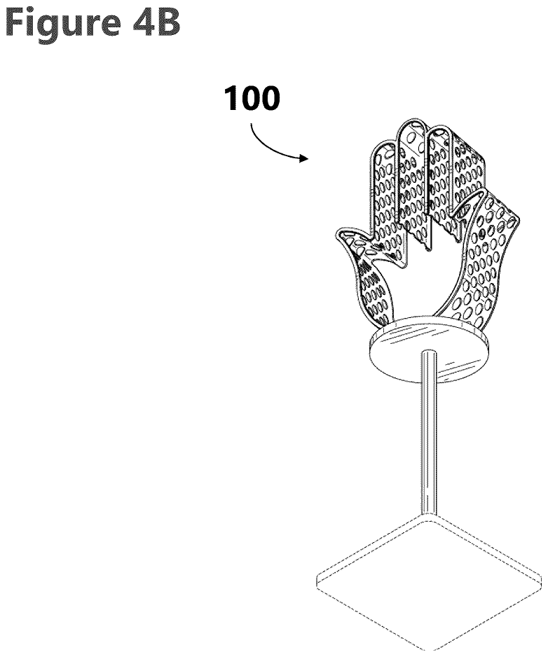

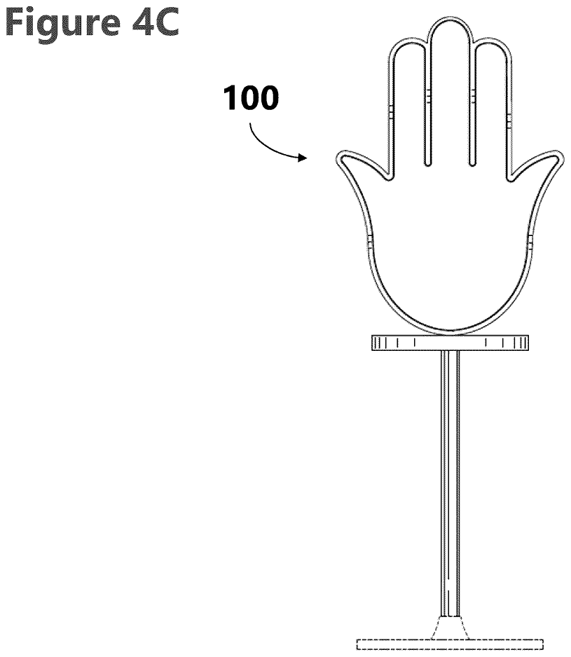

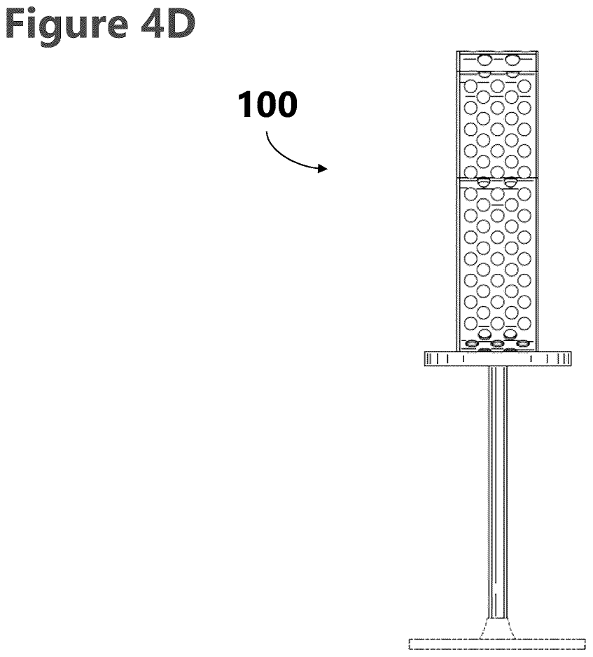

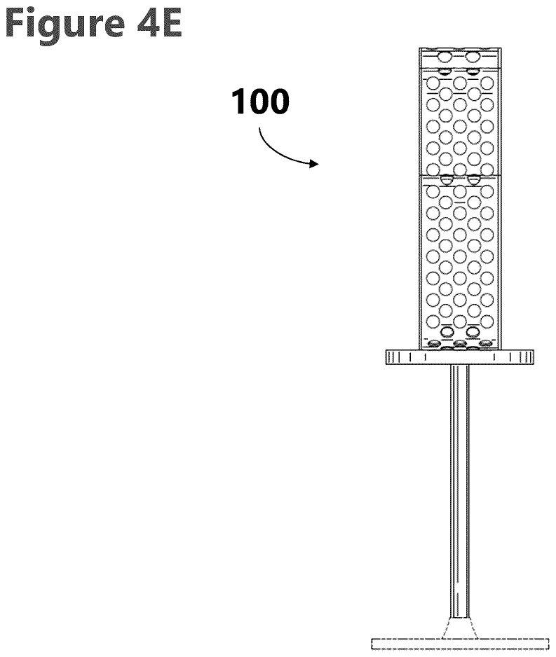

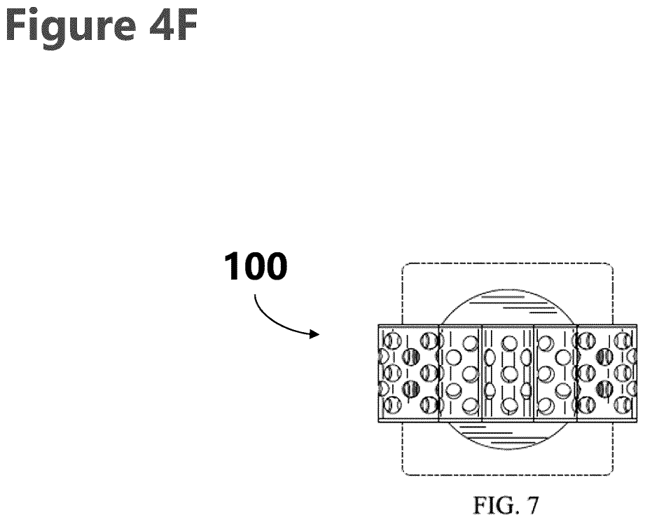

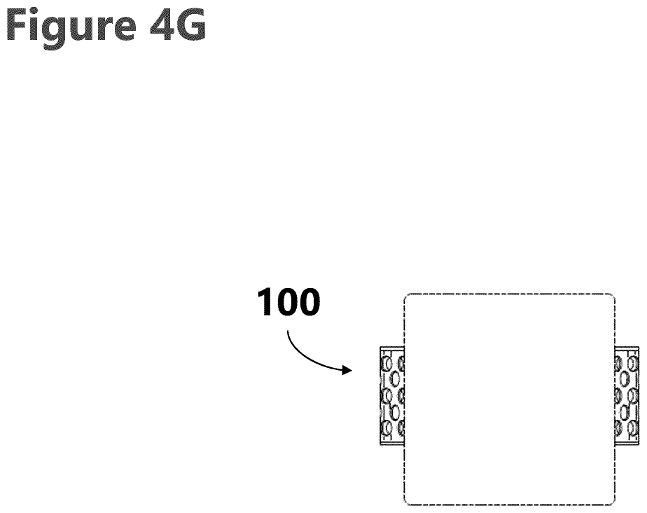

FIG. 4A shows, for purpose of illustration and not limitation, a perspective view of system 100. Decorative fixture 101 can be formed in a three-dimensional design. The design can use a perforated metal that can let light pass through and create shadows. These shadows can do more than simply mark the passage of light; they can form intricate patterns on surrounding surfaces, transforming ordinary illumination into a dynamic display of art. The interplay between light and shadow can added a unique visual dimension, making each moment and angle a part of the creative experience. Although the decorative fixture 101 is shown formed of metal with round perforations, decorative fixture 101 can include any suitable perforations or designs that do not include perforations. FIG. 4B shows a bottom perspective view of system 100. FIG. 4C shows a front view of the system 100. FIGS. 4D and 4E show left and right-side views, respectively, of the system 100. FIGS. 4F and 4G show top and bottom views, respectively, of the system 100.

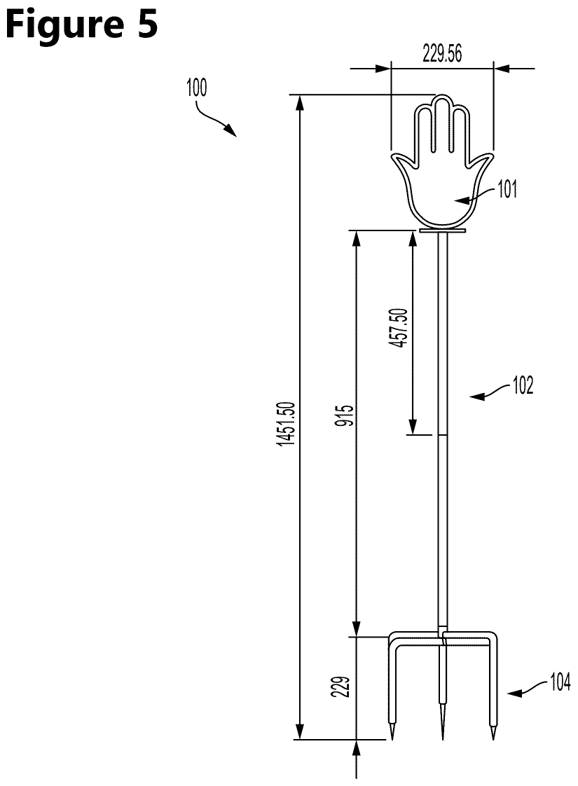

FIG. 5 provides, for purpose of illustration and not limitation, exemplary dimension for system 100. For example, the system of 100 can be a total of 1451.50 mm, with the extension rod 102 totaling around 915 mm and one section being roughly 457.50 mm and the pronged end 104 being roughly 229 mm. The width of the decorative fixture 101 can be around 229.56 mm. The width of decorative fixture 101 can range from 100 to 400 mm. The depth can range from 20 to 250 mm.

Although system 100 is shown with one extension rod 102, any suitable number of extension rods can be provided (for example, 2, 3, 4 or more extension rods) which can allow decorative fixture 101 of system 100 to be held at various heights.

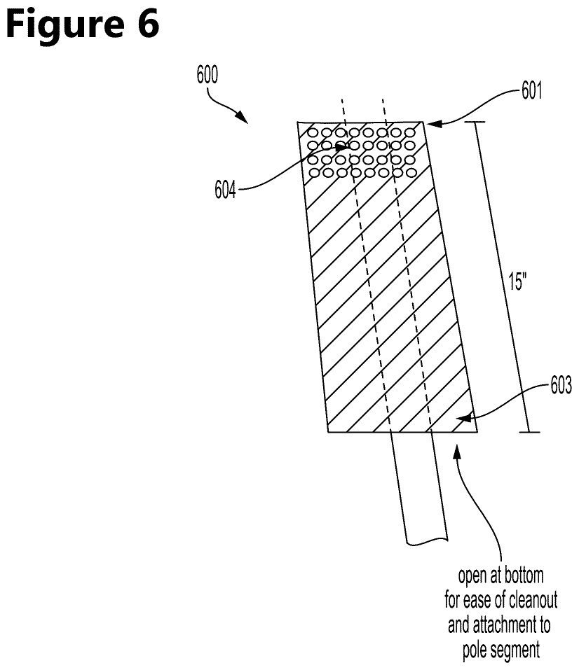

FIGS. 6-9 illustrate further exemplary configurations of system 100. In accordance with the disclosed subject matter, the system can be configured to accommodate decorative accessories between its segmented components without compromising the structural integrity of the assembled unit. The pole can include multiple segments that are joined via screw connections, allowing for secure attachment and modular customization. The decorative system can include a standardized attachment feature shared by both bases, where one side of the extension rod is the same, and the attachment feature for the decorative fixture and one side of the extension rod are the same. These two types of attachment features are complementary, allowing the decorative fixture to be interchangeably coupled with either the base or the extension rod. All decorative fixtures are configured with the same attachment interface to enable easy substitution. Additionally, multiple extension rods can be used in combination to achieve varying installation heights.

FIG. 6 provides, for purpose of illustration and not limitation, an exemplary decorative fixture 101 for system 100. For example, a climbing trellis tube 600 designed to support vertical plant growth in a garden environment can be added to extension rod 102 or the first attachment feature 110. The climbing trellis tube can include a 15-inch perforated cylindrical element 601 constructed from the same metal finish as the pole and topper components, ensuring visual and material consistency across the system. The tube features an open-bottom 603 which allows for ease of attachment to extension rod 102 or the first attachment feature 110. The design also allows for quick installation and removal for cleaning and seasonal maintenance. The tube 600 can be configured to connect to the pole at the top of one of the pole segments. This design facilitates easy installation and removal, particularly useful for seasonal maintenance such as clearing out vines and greenery at the end of the growing season. The top of the tube includes a portion of holes 604 that allow for plants to be planted through the openings. Multiple climbing trellis tubes can be used on a single pole assembly to promote continued vertical vegetative growth. The perforated design not only contributes to the aesthetic appeal but also provides structural support for climbing plants, allowing tendrils and stems to anchor naturally to the tube surface.

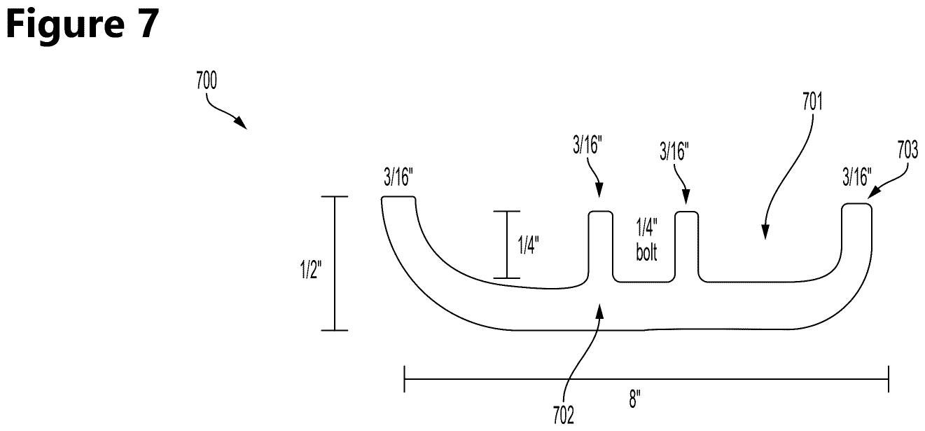

FIG. 7 provides, for purpose of illustration and not limitation, an exemplary decorative fixture 101 for system 100. For example, the decorative fixture 101 can include a birdbath or birdfeeder disc 702 designed for integration with a decorative system. The disc 702 has a diameter of approximately 8 inches and can include a curved, bowl-shaped interior recess 601 with a depth of approximately ¼ inch. This recessed area 701 can be configured to contain water or seed, thereby serving as a feeding or bathing station for birds and other small animals. The disc 702 can also include a rim 703 surrounding the recessed area, which can provide a stable surface for birds to land and access the contents of the bowl.

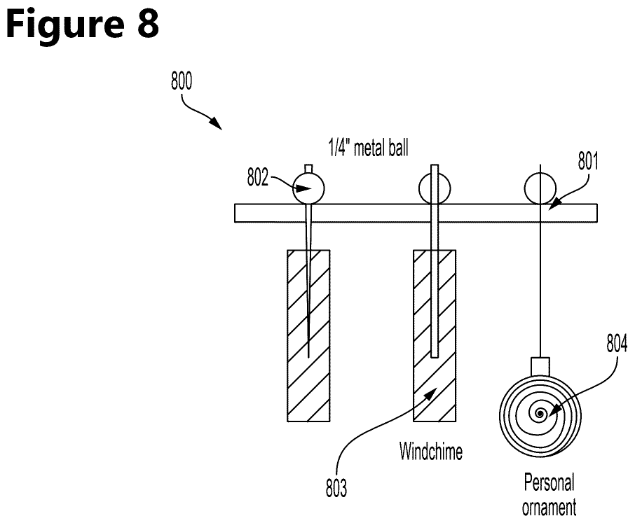

FIG. 8 provides, for purpose of illustration and not limitation, an exemplary decorative fixture 101 for system 100. For example, the decorative fixture 101 can include a panel 801, which can include a windchime 803 or personal ornament 804 designed for integration with a decorative system. The panel 801 can have a diameter of approximately 8 inches and can feature a specialty perforated design that allows for the attachment of decorative elements such as a windchime 803 or personal ornament 804. The panel 801 can be positioned either atop a pole segment or between segments, providing flexibility in aesthetic arrangement and functional use. A user can attach ornaments 804 to the panel 801 through its perforated holes in the panel 801 using specialized hangers. The hangers are connected to weighted balls 802 that facilitate movement in response to the wind. The ornaments 804 can be user-supplied or selected from a kit that includes components matching the symbolic and geometric design elements of the pole topper. In addition, the user can modify the acoustic output of the windchime 803 by repositioning them around the panel 801, thereby altering the interaction between the windchimes 803 and the wind. When the panel 801 is placed at the topmost section of the pole, the top can be secured into the center of the panel 801 via a threaded connection, maintaining the structural and visual integrity of the overall assembly.

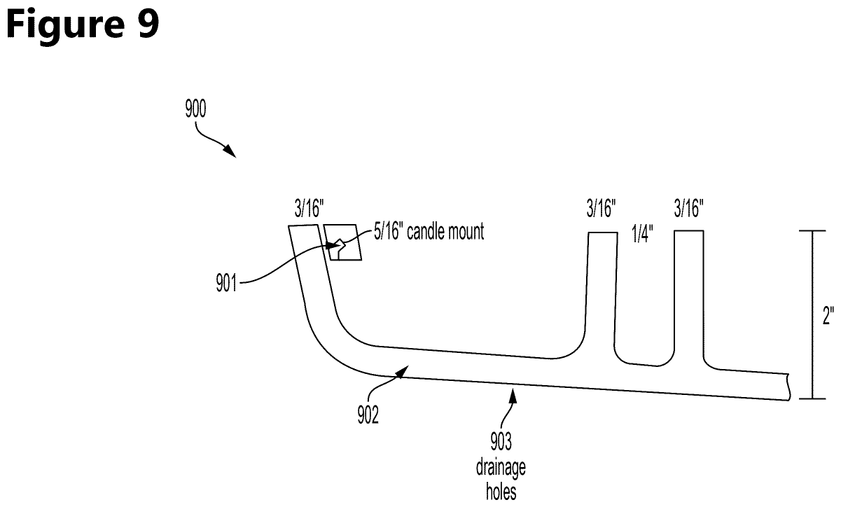

FIG. 9 provides, for purpose of illustration and not limitation, an exemplary decorative fixture 101 for system 100. For example, the decorative fixture 101 can include a dual-function planter and menorah decorative fixtures 900 designed for integration with the decorative system 100. The disc 902 has a diameter of approximately 8 inches and features a deeper bowl-shaped interior than the birdbath/birdfeeder variant. This recessed area can be configured to hold soil and plants, and can include perforations 803 at the bottom of the bowl to allow for water drainage, thereby supporting healthy plant growth. The disc 902 also incorporates nine recessed candle holders 901 spaced evenly around the perimeter of the bowl. These candle holders 901 are dimensioned to securely accommodate standard candles, enabling the disc 902 to function as a menorah during the Jewish Hanukkah holiday or for general candlelight use. The dual-purpose design allows users to transition between decorative planting and ceremonial lighting as desired.

In accordance with the disclosed subject matter, the disclosed subject matter includes a decorative system including a decorative system including a stabilizing rod having a first end with a plurality of prongs configured to penetrate the ground and a second end; a base with a receiving aperture, wherein the base is configured to be disposed on a surface; and at least one decorative fixture 101 configured to selectively couple with either the second end of the stabilizing rod in a first configuration or with the receiving aperture of the base in a second configuration.

Aspects of the disclosed subject matter are set out in the claims, and additional features are further described in the dependent claims and within the disclosure. Additional features can be provided in combination with the decorative system.

In accordance with the disclosed subject matter, the disclosed subject matter includes a decorative system including decorative fixture 101 for tabletop placement.

In accordance with the disclosed subject matter, the disclosed subject matter includes a method for assembling the decorative system including both bases depending on the user's preference.

It will be apparent to those skilled in the art that various modifications and variations can be made in the system of the disclosed subject matter without departing from the spirit or scope of the disclosed subject matter. Thus, it is intended that the disclosed subject matter include modifications and variations that are within the scope of the appended claims and their equivalents.

What is claimed is:

1. A decorative system, comprising:
a first base having a first end including a plurality of prongs configured to penetrate a ground and a second end having a first attachment feature;
a second base having a first end including a flat bottom configured to be disposed on a surface and a second end having a second attachment feature;
an extension rod having a first end having a third attachment feature and a second end having a fourth attachment feature; and
a decorative fixture having a first end including a fifth attachment feature;
wherein the first attachment feature and second attachment feature are each respectively configured to selectively couple with at least one of the fourth attachment feature and the fifth attachment feature, and wherein the third attachment feature is configured to selectively couple with the fifth attachment feature.

2. The decorative system of claim 1, wherein the first, second and third attachment features each comprise a female end, and the fourth and fifth attachment features comprise a male end.

3. The decorative system of claim 2, wherein the female and male ends are configured for threaded engagement.

4. The decorative system of claim 1, wherein the first, second and third attachment features each comprise a magnet having a first polarity extending in a first direction, and the fourth and fifth attachment features each comprise a magnet having a second polarity extending in a second direction.

5. The decorative system of claim 1, wherein the second base is configured to support the
at least one decorative fixture on the surface.

6. The decorative system of claim 5, wherein the at least one decorative fixture includes at least one of a birdbath, a birdfeeder, a decorative ornament, a religious symbol, a plant holder, or a trellis.

7. The decorative system of claim 6, wherein the birdbath and feeder include a recessed bowl configured to receive water or birdseed.

8. The decorative system of claim 6, wherein the decorative ornament includes a perforated disk panel and at least one ornament having a lead attachable to the disk panel.

9. The decorative system of claim 6, wherein the at least one decorative ornament includes a windchime, a seasonal ornament, or a windmill.

10. The decorative system of claim 9, wherein the at least one decorative ornament includes hangers with weighted balls.

11. The decorative system of claim 6, wherein the religious symbol includes at least one of a menorah, Hamsa, mezuzah, depiction of a human, or cross.

12. The decorative system of claim 6, wherein the plant holder includes a disk panel having a plurality of drains.

13. The decorative system of claim 12, wherein the disk panel includes a plurality of holders dimensioned to receive a candle therein.

14. The decorative system of claim 6, wherein the trellis includes a cylindrical tube defining a plurality of windows configured to receive plants thereto, wherein the cylindrical tube surrounds at least a portion of the extension rod.

15. The decorative system of claim 1, wherein the at least one decorative fixture includes a perforated segment defining a plurality of windows, wherein the perforated segment is configured to block light from shining therethrough and is configured to impart a shadow on the ground or the surface

16. The decorative system of claim 1, wherein the rod and the fixture comprise at least one of plastic or metal.

17. The decorative system of claim 16, wherein the rod and the fixture include a protective weather coating.

18. The decorative system of claim 1, wherein the base includes a plurality of lengths and diameters for tabletop placement.

19. A modular decorative system kit comprising:
a first base having a first end including a plurality of prongs configured to penetrate a ground and a second end having a first attachment feature;
a second base having a first end including a flat bottom configured to be disposed on a surface and a second end having a second attachment feature;
at least one extension rod having a first end having a third attachment feature and a second end having a fourth attachment feature;
and decorative fixture having a first end including a fifth attachment feature;
wherein the first attachment feature and second attachment feature are each respectively configured to selectively couple with at least one of the fourth attachment feature and the fifth attachment feature, and wherein the third attachment feature is configured to selectively couple with the fifth attachment feature;
wherein all components are configured for interchangeable assembly without specialized tools, and the kit includes instructions for assembling the system in multiple configurations for ground or tabletop placement.

20. A method of using a decorative system kit, comprising:
providing a modular decorative system kit, including:
a first base having a first end including a plurality of prongs configured to penetrate a ground and a second end having a first attachment feature,
a second base having a first end including a flat bottom configured to be disposed on a surface and a second end having a second attachment feature,
an extension rod having a first end having a third attachment feature and a second end having a fourth attachment feature, and
a decorative fixture having a first end including a fifth attachment feature;
selectively coupling the first attachment feature with at least one of the fourth attachment feature and the fifth attachment feature;
selectively coupling the second attachment feature with at least one of the fourth attachment feature and the fifth attachment feature; and
selectively coupling the third attachment feature with the fifth attachment feature, wherein all components are configured for interchangeable assembly without specialized tools.
